(19) United States
(12) Patent Application Publication
(10) Pub. No.: US 2025/0383148 A1
(43) Pub. Date: Dec. 18, 2025

(54) BURNER APPARATUS

(71) Applicant: Asphalt Burner Services Ltd, Birmingham (GB)

(72) Inventors: Ian Brian Lewis, Birmingham (GB); Jodie McCann, Birmingham (GB)

(73) Assignee: Asphalt Burner Services Ltd, Birmingham (GB)

(21) Appl. No.: 19/241,579

(22) Filed: Jun. 18, 2025

(30) Foreign Application Priority Data
Jun. 18, 2024 (GB) 2408725.6

(51) Int. Cl. F26B 11/02; F23D 11/02; F23D 14/24; F23D 17/00; F23L 7/00; F23L 9/02; F26B 23/02

(52) U.S. Cl. CPC F26B 11/028; F23D 11/02; F23D 14/24; F23D 17/002; F23L 7/002; F23L 9/02; F26B 23/02; F23D 2202/00; F23D 2900/14021

(57) ABSTRACT

The invention provides a burner apparatus comprising:
a combustion chamber (8);
   a fuel dispenser (15, 16) arranged to direct a flow of fuel into the combustion chamber (8), the fuel dispenser (15, 16) being located at an upstream end of the combustion chamber and being connected or connectable to a fuel supply;
   an airflow modifier device (10), located at an upstream end of the combustion chamber, for controlling a primary air flow into the combustion chamber (8), the airflow modifier device (10) being configured to facilitate mixing of the air with the fuel to give a mixture for combustion; and
   one or more secondary air channels (24) for directing a cooling secondary air flow onto a stream of combustion products (e.g. flame) as the stream of combustion products emerges from a downstream end of the combustion chamber.

Also provided are a dryer apparatus comprising a burner apparatus as described herein and a method of drying aggregates using a burner apparatus as described herein.

### CROSS REFERENCE TO RELATED APPLICATIONS

This application claims priority to United Kingdom Application No. GB 2408725.6, filed on 18 Jun. 2024, the entire contents of which are hereby incorporated by reference herein.

This invention relates to a burner apparatus and more particularly to a burner apparatus for use in conjunction with dryers such as a rotary dryer or kiln, for example a rotary dryer of the type used for the drying of aggregates.

### BACKGROUND TO THE INVENTION

Asphalt is the name used in the UK and Europe to denote the material used in road building and other civil engineering applications, which comprises aggregates (e.g. crushed rock, gravel, shingle, sand and recycled broken-up asphaltic road surface material) coated in bitumen. In the USA, this material is generally known as asphalt concrete.

The aggregates used in making asphalt typically contain substantial quantities of water, either because of the wet nature of the medium from which they have been extracted, or because they have been left out in the open and have therefore been exposed to atmospheric moisture. Consequently, the aggregates need to be dried before use. Moreover, in order to ensure efficient mixing of the aggregates and bitumen and maximise the binding of the bitumen to the aggregates, it is desirable that the aggregates be heated prior to mixing with the bitumen. For these reasons, the aggregates used in making asphalt tend to be heated to temperatures in the range of 150 to 190° C. or higher. In some asphalt mixes, such as hot rolled asphalt (HRA), temperatures as high as 220 to 230° C. are used.

A typical asphalt plant will therefore comprise a dryer for drying and heating the aggregates. A common form of dryer used in asphalt plants is a rotating drum dryer, in which the heat for the drying process is provided by one or more combustion burners at one end of the drum. Air is drawn through the combustion burners, and the heated gases from the burner pass along the interior of the rotating drum and out through a gas exhaust outlet at the far end of the drum. The stream of hot gases from the burner passing through the drum serves to dry the aggregates. In order to facilitate the drying and heating processes, the internal side wall of the drying zone of the drum is provided with a series of scoops or blades that scoop up the aggregates from the floor of the drum, lift them to the high point of revolution of the drum, and then drop them so that they fall back as a curtain of aggregates through the stream of hot gases to the floor of the drum. In most known types of drum dryers, either a contra-flow arrangement is used in which the drum is inclined so that the drying aggregates gradually migrate from an inlet at the end of the drum opposite the combustion burner towards the end at which the burner is located, or a parallel flow arrangement is used where the burner is fitted at the same end as the aggregate inlet. Once they have reached the burner end, the dried hot aggregates are discharged into a conveyor device, such as a bucket lift, which carries them to hot aggregate storage containers where they are stored prior to being mixed with hot bitumen to form asphalt.

One such dryer and a burner therefor are described in our earlier International patent application WO 2013/160306.

A problem with many known dryers is that the combustion of commonly employed fuels leads to the formation and release of nitrogen oxides and sulphur dioxide.

When fuel burns, the high temperatures create an environment where diatomic molecular nitrogen (N₂) from the air can react with oxygen to form unwanted nitrogen oxide by-products. Some examples of common nitrogen oxides are nitrous oxide (N₂O), nitric oxide (NO) and nitrogen dioxide (NO₂) which together are represented by the formula NOₓ.

Sulphur dioxide (SO₂) emissions arise from the burning of fuels which contain sulphur impurities. Fuels such as coal, coal-based smokeless fuels, fuel oil and petroleum coke can all have high sulphur content and result in significant sulphur dioxide emissions.

Oxides of nitrogen are not only an important air pollutant by themselves, contributing to the development of serious respiratory illnesses such as asthma and chronic bronchitis, but they can also help acid rain formation, produce tropospheric ozone (O₃), and take part in other destructive cycles.

Tropospheric ozone is ozone found in the ambient air that we breathe and therefore its presence is hazardous and can trigger a variety of health problems. In contrast, stratospheric ozone protects us and the troposphere from ionizing radiation coming from the sun.

N₂O is an ozone-depleting substance which reacts with O₃ in both the troposphere and in the stratosphere. Thus, N₂O emissions lead to the degradation of stratospheric ozone which is vital for providing protection from ionizing radiation coming from the sun. N₂O is also a “Greenhouse Gas” which, like carbon dioxide (CO₂), absorbs long wavelength infrared radiation to hold heat radiating from Earth, and thereby contributes to global warming.

Oxidation of N₂O by O₃ can occur at any temperature and yields both molecular oxygen (O₂) and either NO or two NO molecules joined together as its dimer, dinitrogen dioxide (N₂O₂).

Emissions of NOₓ from combustion are primarily in the form of NO. NO is generated to the limit of available oxygen (about 200,000 ppm) in air at temperatures above 1,300° C. NO produces the same failure to absorb oxygen into the blood as carbon monoxide (CO) and thus is hazardous to health. Additionally, NO or N₂O₂ oxidises rapidly to NO₂ in the presence of oxygen.

NO₂ reacts in the presence of air and ultraviolet light (UV) in sunlight to form ozone and nitric oxide (NO). The NO then reacts with free radicals in the atmosphere, which are also created by the UV acting on volatile organic compounds (VOC). The free radicals then recycle NO to NO₂. In this way, each molecule of NO can produce ozone multiple times. This will continue until the VOC are reduced to short chains of carbon compounds that cease to be photo reactive.

When any of the above-mentioned nitrogen oxides dissolve in water and decompose, they form nitric acid (HNO₃) or nitrous acid (HNO₂). Nitric acid forms nitrate salts when it is neutralized. Nitrous acid forms nitrite salts. Thus, NOx and its derivatives exist and react either as gases in the air, as acids in droplets of water, or as salts. These gases, acid gases and salts together contribute to pollution effects that have been observed and attributed to acid rain.

Because NO₂ is recycled from NO by the photo reaction of VOC to make more ozone, NO₂ seems to have an even longer lifetime and is capable of travelling considerable distances before creating ozone. Weather systems usually travel over the earth's surface and allow the atmospheric effects to move downwind for several hundred miles. Therefore, nitrogen oxide emission can cause wide-reaching health and environmental impacts. Similarly, sulphur oxides (SOₓ) are a group of hazardous compounds which upon exposure contribute to the onset of serious respiratory illnesses such as asthma and chronic bronchitis. Much like nitrogen oxides, sulphur dioxide emissions react with water, oxygen, and other chemicals to form acidic compounds such as sulphuric acid (H₂SO₄) and sulphurous acid (H₂SO₃). These compounds lower the pH of the water which falls as acid rain which can have significant environmental and health effects.

Acid rain formed through nitrogen oxide or sulphur dioxide emissions is corrosive and can cause plants to be damaged, slowing growth or even killing them, as well as accelerating the weathering of monuments and other man-made buildings. Rainfall with a lower pH can also cause soil acidification, nutrient loss in the soil, and acidification of bodies of water. These effects can seriously harm ecosystems and disrupt food chains.

Reducing the amount of oxygen available is not a viable solution for limiting NOₓ and SOₓ formation during combustion, as limiting the availability of oxygen during combustion can lead to inefficient or incomplete combustion, resulting in the formation of carbon monoxide and the presence in combustion gases of unburnt fuels. In addition to being atmospheric pollutants, unburnt fuels will condense on the bag filters used in many aggregate drying plants shortening the useful life of the filters thereby increasing costs in replacement bags.

Hitherto, it has proved difficult to control the flame temperature in asphalt plant dryers and, typically, the burners used in asphalt plant dryers tend to produce flames with temperatures exceeding 1204° C., at which higher temperatures, large quantities of nitrogen oxides are typically formed during the combustion of common fuels. As a consequence, asphalt dryer plants typically give rise to high nitrogen oxide emissions. Therefore, at present there remains a need for asphalt plant dryers which possess the ability to control combustion temperature in order to limit NOₓ and SOₓ emissions, but without reducing the efficiency of the combustion process.

### BRIEF SUMMARY OF THE INVENTION

It has now been found that by directing a stream of air onto a flame as it emerges from a combustion chamber, it is possible to reduce the flame temperature below 1204° C. or limit the residence time at peak temperature, thereby reducing the oxidation of nitrogen to nitrogen oxides (NOₓ).

Accordingly, in one aspect, the invention provides a burner apparatus comprising:
a combustion chamber;
a fuel dispenser arranged to direct a flow of fuel into the combustion chamber, the fuel dispenser being located at an upstream end of the combustion chamber and being connected or connectable to a fuel supply;
an airflow modifier device, located at an upstream end of the combustion chamber, for controlling a primary air flow into the combustion chamber, the airflow modifier device being configured to facilitate mixing of the air with the fuel to give a mixture for combustion; and
one or more secondary air channels for directing a cooling secondary air flow onto a stream of combustion products as the stream of combustion products emerges from a downstream end of the combustion chamber.

According to the invention, a flow of fuel is directed into the combustion chamber where it is mixed with the primary air flow and subjected to combustion. The airflow modifier device is configured to facilitate mixing of the air with the fuel to give a mixture for combustion and typically does this by introducing turbulence into the airflow to assist turbulent mixing of the fuel and air. An ignition device is provided for initiating combustion at start-up to produce a flame which extends beyond the downstream end of the combustion chamber. At the downstream end of the combustion chamber, the secondary airflow is directed onto the flame as it emerges from the combustion chamber, thereby exerting a cooling effect on the flame. By cooling the flame below about 1204° C., the amount of NOx produced can be significantly reduced. A further advantage of directing a flow of secondary air onto the flame is that it can bring about combustion of any unburnt fuel in the stream of combustion products. Yet a further advantage of this arrangement is that it reduces the heat transfer to the outer wall/shell of the combustion chamber, thereby prolonging the working life of the burner.

The fuel used in the burners of the invention is typically a liquid or gas at room temperature. For example, the fuel may be a liquid or gaseous hydrocarbon, a hydrocarbon mixture, an ether such as dimethyl ether (e.g. rDME), biofuels (such as BioLPG, bio-ethanol and bio-diesel), waste oils, ammonia or hydrogen.

When the fuel is a liquid (e.g. a liquid hydrocarbon or a liquid biofuel), the fuel dispenser may be an atomising nozzle which converts a liquid fuel stream into a flow of atomised liquid particles.

When the fuel is a gas (e.g. hydrogen or a hydrocarbon gas such as natural gas), the fuel dispenser is typically a gas ring positioned so as to surround a longitudinal axis of the combustion chamber.

Because of the presence of the airflow modifier element, which is typically configured to impart twist to the primary airflow, the flame emerging from the combustion chamber has a swirling form and this facilitates mixing with the secondary airflow.

The airflow modifier device is typically positioned in an upstream opening into the combustion chamber and is configured to provide one or more (typically multiple) flow paths for the primary air into the combustion chamber. The airflow modifier device is configured to introduce turbulence into the primary airflow so as to facilitate mixing of the primary airflow with the fuel. The airflow modifier device may therefore be provided with one or more vanes which impart twist to the primary airflow as it enters the combustion chamber along flow paths between the vanes. In one embodiment, the airflow modifier device takes the form of a swirl plate comprising an array of linked radially extending angled vanes for imparting twist to the primary airflow.

The airflow modifier device may comprise separate radially inner and radially outer airflow modifier elements, each of which is provided with one or more surfaces for altering the direction of the primary airflow. The separate radially inner and radially outer airflow modifier elements may be contiguous, or they may be radially spaced apart.

When the fuel to be used with the burner is a gas, such as hydrogen, a gas ring connected or connectable to a source of the gas may be located in the upstream opening into the combustion chamber. The gas burner ring can be positioned forwardly or rearwardly of an airflow modifier element or can be located in substantially the same plane (orthogonal to the longitudinal axis of the burner) as the airflow modifier element.

In one embodiment, a first airflow modifier element (e.g. a swirl plate) is disposed radially inwardly of (and typically concentrically with) the gas ring and a second airflow modifier element is disposed radially outwardly of (and typically concentrically with) the gas ring.

The swirl plate may comprise radially inner and outer zones having different numbers of angled vanes. For example, in one embodiment, the radially outer zone may have a greater number (e.g. twice the number) of vanes than the radially inner zone). In this embodiment, the air gaps between the vanes are typically larger in the radially inner zone than in the radially outer zone.

The one or more secondary air channels are typically arranged to surround the combustion chamber so as to produce a secondary air flow that at least partially surrounds and mixes with the flame as it emerges from the combustion chamber.

In a particular embodiment, the secondary air flow is arranged to completely surround the stream of combustion products as it emerges from the combustion chamber, thereby ensuring more efficient mixing and a more rapid cooling of the flame to a desired temperature.

In one embodiment of the invention, the one or more secondary air channels comprise a single annular chamber which encircles the exterior of the combustion chamber. In this embodiment, a wall of the combustion chamber may comprise inner and outer skins whereby the annular chamber is located between the inner and outer skins.

Alternatively, the one or more secondary air channels may instead comprise a discontinuous annular chamber or an array of pipes that encircle the combustion chamber, thereby allowing the rate of secondary air flow to be varied at different points around the circumference of the combustion chamber.

In a further embodiment, the combustion chamber and the one or more secondary air channels may be configured to have separate primary and secondary air intakes, respectively. In this embodiment, the combustion chamber and the one or more secondary air channels are typically arranged to be isolated from each other to allow no passage of air between the combustion chamber and the secondary air channel(s). The primary and secondary air intakes may be connected to separate sources of air, for example, separate fans. The use of separate air intakes provides greater independent control over the primary and secondary air flows thereby facilitating far greater control over the flame temperature and reduction of NOx emissions.

Alternatively, the secondary airflow may be provided at least partially by diverting a proportion of the primary airflow into the one or more secondary air channels (e.g. into the secondary air chamber). The said proportion of the primary airflow may be diverted to form the secondary airflow before the primary airflow enters the combustion chamber, or it may be diverted from within the combustion chamber in such a way that there is substantially no mixing of the said proportion of the primary airflow with fuel before it is diverted. Thus, in one embodiment, the secondary airflow is substantially free from fuel.

In this alternative embodiment, the combustion chamber and secondary air channel may be configured to use a common air intake. In this embodiment, the combustion chamber is typically provided at or adjacent an upstream end thereof with a set of apertures in its wall(s) communicating with the one or more secondary air channels. This allows for primary air flow from the combustion chamber to pass into the one or more secondary air channels. Thus, the primary air intake can give rise to both the primary and secondary air flow, alleviating the need for separate secondary air intake(s) and simplifying construction.

The secondary air chamber may be provided with one or more drain channels. The channels are in fluid communication with the secondary air chamber and allow any unspent fuel which may accumulate within the secondary air chambers to be drained. The drain channels may be provided with drain plugs that can be used to seal the drain channels when the apparatus is in use.

An airflow control device (or radially outer airflow modifier element) can be configured to divert a proportion of the primary airflow radially outwardly so that it passes through the apertures before coming into contact with fuel.

The airflow control device (or radially outer airflow modifier element) can be configured to vary the proportion of the primary airflow diverted through the apertures thereby to vary the volume of air passing through the secondary air channel(s) (e.g. secondary air chamber). Alternatively, or additionally, the size of the apertures can be variable to control the volume of air therethrough.

Preferably, the airflow control device is mounted in or across an inlet at the upstream end of the combustion chamber such that there is a gap constituting an air escape channel around a periphery of the airflow control device (or where present the radially outer airflow modifier element), the airflow control device having one or more windows therein through which a flow of air provided by the fan is directed into the combustion chamber to mix with atomised fuel from the burner nozzle, the one or more windows being configured to impart turbulence to the airflow.

Generally, the rate of secondary air flow can be varied by adjusting the speed of the motor of a fan which controls the rate of air intake.

The one or more secondary air channels (e.g. a secondary air chamber) are configured to direct the cooling secondary airflow onto the stream of combustion products emerging from the downstream end of the combustion chamber. The one or more secondary air channels may therefore be provided with an angled surface or surfaces for directing the secondary airflow radially inwardly and into contact with the stream of combustion products. The angled surfaces may be angled such that the secondary air flow leaves the one or more secondary air channels at an angle of from about 10° to about 45°, more usually from about 15° to about 35°, relative to a central axis extending through the combustion chamber.

In certain embodiments, the burner is preferably provided with a fixed or movable secondary air director element at the downstream end of one or more secondary air channels, which directs secondary air flow into the existing flame. Typically, the secondary air director element can be adjusted to control the angle at which air emerges from the one or more secondary air channels. Secondary air flow typically emerges at angles ranging from 10° to 60°, more typically from 15° to 40°, such as 30°.

The one or more secondary air channels can be constructed with multiple downstream outlets for introducing secondary air into the existing flame. The outlets can be situated at various distances downstream of the burner nozzle, allowing the cooling secondary air flow to be introduced into the existing flame and/or stream of combustion products at multiple locations, allowing for greater control over flame temperature and a reduction in NOx emissions. Optionally, some or all of the outlets may be equipped with a moveable element that allows them to be opened and closed.

In addition to providing a stream of secondary air to cool the flame after its emergence from the combustion chamber, the flame may also be cooled by injecting a cooling water mist into the flame. Accordingly, the fuel dispenser of the apparatus of the invention may comprise a fuel-dispensing lance which, in addition to dispensing fuel and optionally air, is capable of dispensing a water mist into the flame.

In one embodiment, the apparatus of the invention can comprise a burner lance having one or more fuel channels each connected or connectable to a source of fuel, an air channel connected or connectable to an air inlet, and a water channel connected or connectable to a source of water and having a spray-dispensing outlet for spraying a water mist into the flame.

The fuel channel(s) is/are typically connected or connectable to a source of liquid fuel and is provided with one or more atomising outlets for dispensing the fuel in atomised form. The burner lance may deliver a single type of fuel, in which case it has a single fuel channel connected/connectable to the source of fuel. Alternatively, the burner lance may deliver multiple (e.g. two) types of fuel at the same time, via multiple (e.g. two) fuel channels, each fuel channel being connected/connectable to a separate source of fuel. The two fuel channels may converge to a single outlet at the burner lance nozzle, where the fuel is combusted. When the burner lance is for delivery of two or more types of fuel, the fuels can be burned simultaneously or separately (e.g. sequentially). Accordingly, the burner lance may comprise two independent fuel inlets, each of which is in fluid communication with separate fuel channels. The fuel conduits convey fuel from the inlets (which are typically located at an upstream end of the lance) to the atomising nozzle, where they can be combusted.

Thus, in another embodiment, the apparatus of the invention can comprise a burner lance having two or more fuel channels each connected or connectable to a source of fuel, and an air channel connected or connectable to an air inlet.

As an alternative to the apparatus comprising a single burner lance configured to supply two fuels, it will be appreciated that the apparatus may comprise two burner lances, each arranged to supply a different fuel to the combustion chamber.

The fuel channel(s) may be arranged to connect with the air channel so that a mixture of air and atomised fuel is dispensed through the one or more atomising outlets.

In a particular embodiment, the burner lance has a spray-dispensing outlet for spraying a water mist wherein the spray dispensing outlet lies on a longitudinal axis of the burner lance, and one or more one or more atomising fuel dispensing outlets which are offset (i.e. are located radially outwardly of) with respect to the said longitudinal axis. The position of the spray-dispensing outlet allows for water vapour to be injected directly to the middle of the flame. This can help with reducing the flame temperature, e.g. to avoid the formation of nitrogen oxides, as discussed herein.

The burner lance may comprise a stem portion and, at a downstream end thereof, an atomising head;
wherein the stem portion has a central water channel extending along the length thereof, an annular fuel channel surrounding the central water channel, and one or more air channels disposed radially outwardly of (for example surrounding) the annular fuel channel; and
wherein the atomising head is provided with the water spray dispensing outlet and the one or more one or more atomising fuel dispensing outlets as hereinbefore defined.

Whilst the aforementioned burner lance is envisaged primarily as being useful in the burner apparatus of the invention, it may also be useful in burners other than those described and disclosed herein.

Accordingly, in a further aspect, the invention provides a burner comprising a burner lance having one or more fuel channels connected or connectable to one or more sources of fuel, an air channel connected or connectable to an air inlet, and a water channel connected or connectable to a source of water and having a spray-dispensing outlet for spraying a water mist into a flame created by the burner.

In a still further aspect, the invention provides a burner comprising a burner lance having two or more fuel channels connected or connectable to one or more (e.g. two or more) sources of fuel, an air channel connected or connectable to an air inlet, and optionally a water channel connected or connectable to a source of water and having a spray-dispensing outlet for spraying a water mist into a flame created by the burner.

Particular embodiments of the burner lance as are set forth above and in the detailed description and drawings herein.

The burner lance may be movable in a direction towards/away from the combustion chamber. This allows for the lance position to be varied depending on the specific types of fuel to be used in order to aid in reducing flue gas emissions. The optimal distance between the burner lance nozzle and the ignitor may also vary depending on the fuel being used. Therefore, a movable burner lance may be useful to optimise the ignition process.

The burner lance may be movably mounted on a positioning system. For example, the burner lance may be mounted on a carriage or support, which is arranged for substantially axial movement in a direction towards or away from the combustion chamber, e.g. by being able to move along a track of the positioning system. The track typically extends in a direction perpendicular to the opening of the combustion chamber. The positioning system may also comprise one or more linear actuators for moving the burner lance along the track, i.e. towards or away from the combustion chamber). The linear actuator(s) may be electrically, pneumatically or hydraulically controlled. The positioning system may also be provided with one or more sensors for determining the position of the burner lance on the track. The positioning system may then ensure, through a combination of the sensor(s) and actuator(s), that the lance is situated in the correct position for a particular type of fuel.

A securing element (e.g. a clamp) may also be provided (for example, around the circumference of the lance) in order to secure the burner lance at a fixed position along the track. Additionally, or alternatively, there may also be provided a rear stop behind the carriage that can be movably fixed at positions along the track to prevent the lance carriage from moving along the track when in use.

Accordingly, the burner lance can be moved between one or more retracted states, where the burner lance nozzle does not (or at least does not significantly) extend past the airflow modifier device and one or more extended positions where it does. In the retracted state(s), the nozzle is in closer proximity to the ignitor, which may assist with ignition of the main flame. The carriage may be configured to allow the burner nozzle to move by up to 100 mm, for example up to 80 mm or up to 50 mm.

Accordingly, in a further aspect, the invention provides a burner mounted on a positioning system, wherein the positioning system comprises a carriage or moving support onto which the burner lance is mounted, said carriage or moving support being moveable along a track. Particular embodiments of the burner, burner lance and positioning system may be as set forth above and in the detailed description and drawings herein.

Depending on the location of a burner apparatus, i.e. where it is installed relative to other components or other machinery/apparatus, accessing various inlets and/or control inputs (e.g. switches) can be difficult. The present invention therefore also provides a burner apparatus which is interchangeable between a number of different configurations in order to provide greater flexibility regarding the locations in which the apparatus can be installed and used.

The apparatus typically comprises a support structure onto which the various components of the apparatus, for example the combustion chamber, gas ring, lance burner and/or positioning system (where present), can be mounted. As described above, the apparatus may comprise a lance burner positioning system for moving the position of the lance burner along the support structure. Additionally, the gas ring (optionally together with the combustion chamber) may be mounted on the support structure in one or more (for example, two or more, such as four) configurations. Such configurations may be rotatable configurations so that the gas ring inlet can extend in one of a number of directions radially from the gas ring.

Typically, a burner is configured to have its fuel inlet and/or control systems on one side of the burner to suit its existing infrastructure and the environment/surroundings where the burner is installed. The ability to install the gas ring and optionally combustion chamber in more than one rotational position allows greater flexibility with respect to the location of the fuel inlet and control systems, depending on the space surrounding the apparatus in situ. Should the user wish to move the burner to an alternative site, the gas ring and optionally the combustion chamber can be installed in different rotational configurations to accommodate existing space restrictions.

Surrounding the gas ring, there may be a circular wall which encases the gas ring and provides a chamber in which air can be delivered to the gas ring for combustion. The circular wall may have a diameter that is comparable to the diameter of the downstream combustion chamber.

The circular wall is typically fixedly attached to the combustion chamber, such that rotation of the configuration of the circular wall also results in a change in rotational configuration of the downstream combustion chamber. The circular wall may be provided with a number of windows. The windows may be aligned with the positions of the gas ring inlet at each of the rotational configurations, such that the gas ring inlet may extend through one of the windows.

The circular wall may also be provided with removable/interchangeable panels which can be used to occlude the windows. The panels may include components such as control switches (e.g. fuel valve switches, fire switches) that can be removed and relocated at different positions around the combustion chamber to ensure that they are accessible regardless of the location of the apparatus.

Accordingly, in a further aspect of the invention, there is provided a burner apparatus (optionally comprising the features described herein) comprising a gas ring mounted on a support structure in two or more different rotational configurations. Particular embodiments of the burner, gas ring and associated elements to enable different rotational configurations of the gas ring and optionally combustion chamber may be as set forth above and in the detailed description and drawings herein.

The burner is preferably provided with sensors for measuring at least one characteristic of a flame produced by the burner and/or at least one characteristic of the combustion gases produced by the burner. For example, the sensors may provide information on the temperature of the flame and may therefore provide information about NOₓ emissions and extent of combustion of the fuel. Additionally, the burner may be provided with sensors for measuring at least one characteristic of the secondary air flow. For example, the sensors may provide information on the output rate or temperature of secondary air and may therefore provide information about whether secondary air flow needs to be varied to reach an optimal flame temperature.

Alternatively, or additionally, one or more instruments may be positioned at a location downstream of the burner for monitoring the composition of the combustion gases (e.g. NOₓ content) produced by the burner.

Information provided by the sensors enables an operator of the burner to assess flame temperature and hence whether more or less excess secondary air flow is required. The size of the air escape channel (e.g. the air gap around the periphery of the airflow modifier element) or speed of the fan motor can be varied in response to information provided by the sensors. This can be done manually, automatically or semi-automatically. An electronic controller (e.g. a computer or a programmable logic controller (PLC)) can be used to process sensor data and then send appropriate signals to the fan motor to increase or decrease its speed, as well as to actuators to open or close secondary air channel outlets or increase or decrease the size of the escape channel.

The burners of the invention are intended for use as part of an apparatus for drying materials such as aggregates. The combustion chamber of the burner in use is typically mounted adjacent or at least partially within a drying chamber of a dryer.

The dryer may be of the type described in earlier UK patent number GB2485229 and International patent application WO2013/160306, the contents of which are incorporated herein in their entirety, or a dryer as specifically described herein and illustrated in the drawings.

In a further aspect, the invention provides a dryer apparatus (e.g. a rotating drum dryer apparatus) comprising a burner as hereinbefore defined.

The dryer typically comprises a rotating drum, the interior of which, together with associated end walls of the dryer, define a drying chamber. The burner is typically located at an upstream end of the drying chamber and a gas outlet for the heated gases is typically located at a downstream end of the drying chamber, the terms “upstream” and “downstream” in this context referring to the direction of flow of heated gas through the drying chamber. The burner may be mounted so that it extends into an opening in an end wall of the rotating drum, the burner remaining fixed while the drum rotates about it.

The drying chamber typically has an inlet and outlet for particulate materials and the outlet is linked to a conveyer device for conveying dried particulate materials away from the dryer, for example to one or more storage containers.

The rotating drum dryer can be of a Contraflow, Parallel flow, Batch or Continuous mix type.

The rotating drum is typically provided with one or more blades or scoops (collectively referred to herein as “lifters”) on an inner surface thereof for collecting, lifting and releasing the particulate materials so that they fall back through a stream of heated gas flowing from the burner through the drying chamber and, in doing so, are dried. The shape, number and configuration of the lifters can be varied considerably, and the skilled person would be well aware of suitable lifter arrangements for particular dryer drums.

In a contraflow arrangement, the drying chamber is arranged so that there is a contra-flow movement of particulates in the chamber, i.e. the dryer is constructed so that during the drying process, the particulates move from an inlet at the downstream end of the chamber to an outlet at the upstream end of the chamber, the terms “upstream” and “downstream” referring to the direction of flow of combustion products along the chamber. The contra-flow movement may be brought about by inclining the dryer such that its axis is at an angle of 2 to 5 degrees, for example approximately 3.5 degrees, to the horizontal.

In a parallel flow dryer, the burner is mounted at the same end as the inlet for the aggregates.

Rotary dryers of the aforesaid type, suitable for use in conjunction with the burners of the invention, are well known and are commercially available, for example from Vulcan Burners of Tobermore, Northern Ireland, United Kingdom.

The particulate materials dried in the rotary dryers are typically aggregates of the type used in civil engineering applications and include materials such as crushed stone, gravel, sand and like materials, as well as reclaimed asphalt materials obtained by the removal of the asphalt surfaces of roads during renovation and resurfacing work.

The invention also provides a method of drying aggregates, which method comprises passing the aggregates through a dryer apparatus (e.g. a rotating drum dryer apparatus) comprising a burner as hereinbefore defined.

In a still further aspect, the invention provides a method of making asphalt, which method comprises drying aggregates in a dryer apparatus as hereinbefore defined and forming a mixture of molten bitumen and the said aggregates following drying.

In one embodiment, the bitumen is mixed with dried aggregates in a mixer which is separate from the dryer apparatus.

In another embodiment, the bitumen is mixed with dried aggregates in a region of the dryer apparatus.

### BRIEF DESCRIPTION OF THE DRAWINGS

FIG. 1 is a partially sectional side view of a burner apparatus according to one embodiment of the present invention. In FIG. 1, the combustion chamber, secondary air chamber and primary airflow chamber are shown in section.

FIG. 2 is a partially sectional view from above of the burner apparatus of FIG. 1. In this view, the secondary air chamber is shown in section.

FIG. 3 is a view from direction Y of the type of burner apparatus shown in FIG. 1.

FIG. 4 is a view from direction X of the type of burner apparatus shown in FIG. 1 but wherein the unitary airflow modifier element shown in FIG. 1.

FIG. 5 is a sectional view of the combustion chamber of the burner apparatus of FIGS. 1 to 4 but with the gas burner ring and atomising burner nozzle and lance omitted for clarity.

FIG. 6 is an end view of the combustion chamber from FIG. 4 but with the attachment flange, primary airflow chamber and blower module omitted for clarity.

FIG. 7 is a sectional view of the combustion chamber in an apparatus according to a second embodiment the invention.

FIG. 8 is a side view of a airflow modifier device/swirl plate that can be used in the combustion chamber of FIG. 7.

FIG. 9 is a partially sectional view from direction XY of the combustion chamber of FIG. 7, where the inner and outer walls and interior of the secondary airflow chamber are shown in section. In this embodiment, separate concentric inner and outer airflow modifier elements are provided in place of the unitary airflow modifier device of FIG. 8.

FIG. 10 is a sectional view of the combustion chamber of FIG. 7 showing the flow of primary and secondary air and combustion products through the apparatus.

FIG. 11 is a rear view into a primary airflow chamber of the apparatus of FIG. 1 showing the structure of a gas manifold.

FIG. 12 is a partial front view of the upstream end of the interior of the combustion chamber of the apparatus of FIG. 1.

FIG. 13 is a front view of a combustion chamber forming part of an apparatus according to a fourth embodiment of the invention.

FIG. 14 is a side view of a fuel lance capable of dispensing a liquid fuel/air mixture and a water mist which can be used in each of the first, second and third embodiments of the invention.

FIG. 15 is a side sectional view of the nozzle of the fuel lance of FIG. 14 but with the fastening elements (thread and nut profiles) omitted for simplicity.

FIG. 16 is a schematic view of the cooling water spray system for the fuel lance of FIGS. 14 and 15.

FIG. 17 is a front view of an apparatus according to a fifth embodiment of the invention.

FIG. 18 is a schematic view of an asphalt manufacturing plant including a dryer incorporating a burner according to the invention.

FIG. 19 is a schematic view of a burner of the present invention installed in a contra-flow rotary dryer.

FIG. 20 is a schematic view of a burner of the present invention installed in a parallel-flow rotary dryer/asphalt mixer.

FIG. 21 is a schematic view of a contra-flow rotary dryer/asphalt mixer.

FIG. 22 is a cross-sectional view of a fuel lance with two fuel feeds and a feed for delivering water to the lance nozzle.

FIG. 23 is a schematic showing an arrangement for adjusting the position of the burner lance with respect to the combustion chamber.

FIG. 24A is an exploded view showing a burner according to one aspect of the invention wherein the gas ring and combustion chamber are mountable in different rotational configurations. FIG. 24B schematically shows the gas ring and combustion chamber mounted in four different rotational configurations.

### DETAILED DESCRIPTION OF THE INVENTION

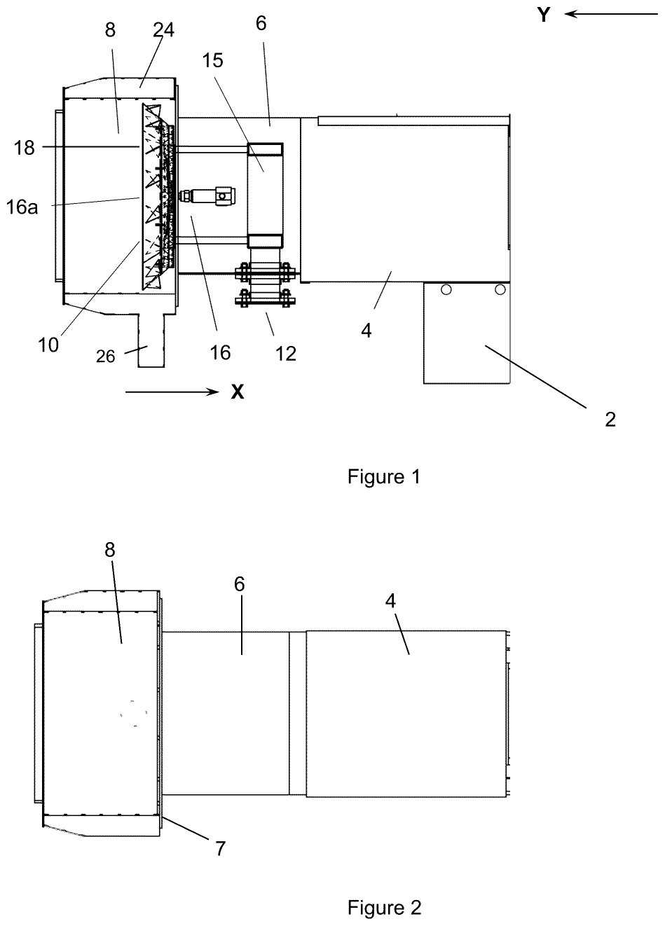

Referring to the drawings, FIGS. 1 to 6, 11 and 12 show a burner apparatus according to one general embodiment of the invention.

The burner apparatus comprises a support structure (2), a blower module (4), a primary airflow chamber (6) and a combustion chamber (8).

Within the blower module, an axial fan is mounted and directly connected to a motor shaft. The motor is situated within a silencer and positioned such that intake air from the burner will also pass over the motor to help cool it. Alternatively, the blower module could comprise a fan chamber inside which is located a fan mounted on a shaft driven by an electric motor. An example of such an alternative fan arrangement is shown in earlier International patent application WO2013/160306 (see in particular FIG. 4A therein).

The support structure (2) serves not only to take the weight of the blower module (4) but also serves as an air intake for the blower module. Typically, in use, the support structure (2) is mounted on a platform at one end of a rotary dryer for drying aggregates used in asphalt manufacture. A circular or square flange plate (7) provided with holes surrounds the downstream end of the primary airflow chamber and this enables the burner to be bolted and held in place on a mounting structure at the end of the rotary dryer.

The platform may have ventilation openings so that air may pass through the platform and up through the support structure (2) and into the blower module (4). Alternatively, the support structure (2) may be provided with feet (not shown) at each corner which elevate the support structure so that there is a gap of about 10 centimetres between the underlying surface and the support structure through which air can pass en route to the fan chamber within the blower module (4). The support structure is configured such that at least 50% of the air required by the burner passes up through the support structure.

In order to reduce the noise associated with the burner, the support structure (2) contains acoustic foam to give noise reduction insulation so that the structure functions as a silencer as well as a support for the blower module.

A primary airflow chamber (6) is positioned between the blower module (4) and the combustion chamber (8) and, in use, receives a flow of primary air from the fan chamber.

The apparatus is capable of burning either liquid fuels, such as liquid hydrocarbons, rDME or liquid biofuels, or gaseous fuels such as natural gas, ammonia or hydrogen. It can therefore be provided with a burner ring for gaseous fuels and/or an atomising fuel nozzle for liquid fuels. In FIG. 1, both types of burner are included by way of illustration and it will be appreciated that a burner can either be set up to operate using only one type of fuel, or it can be set up to burn both types of fuel simultaneously. Indeed, the apparatus can be set up to burn as many as five different fuels.

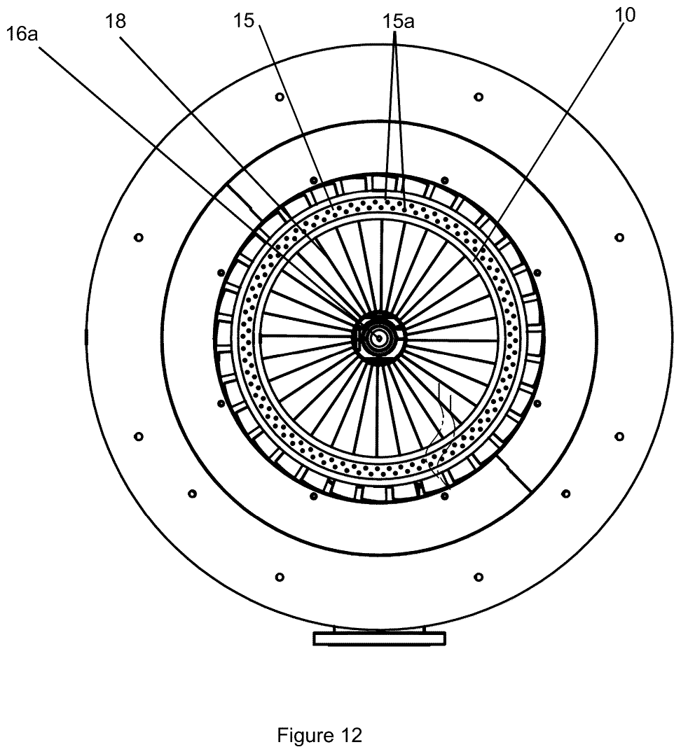

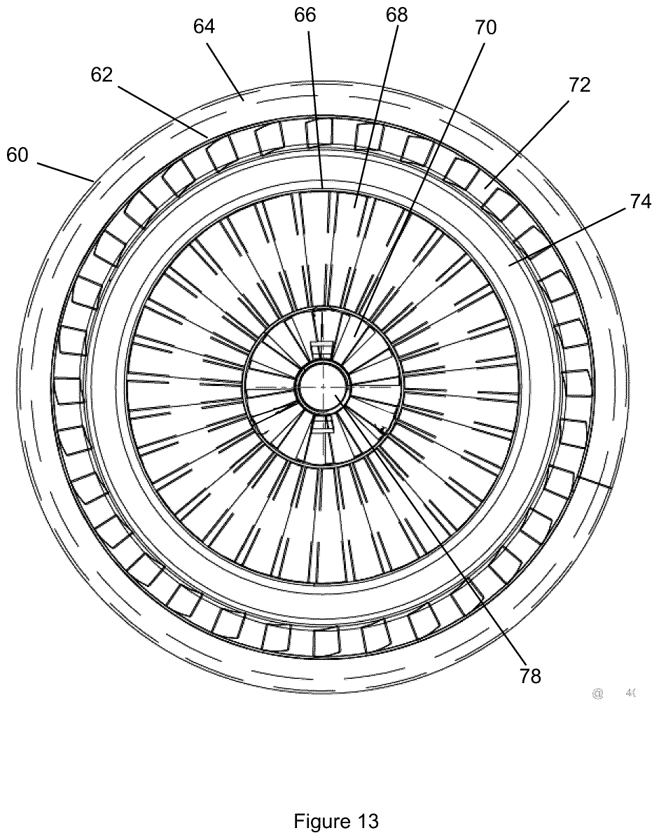

Thus, the primary airflow chamber (6) has mounted therein a gas inlet manifold (12) which is connected via an array of gas tubes to a gas burner ring (15) which is mounted in the upstream opening of the combustion chamber (8) and has an array of forwardly-facing holes (15a) around its circumference through which gas can pass. The three-dimensional structure of the gas manifold is more clearly shown in FIG. 11 and the configuration of the burner ring is shown in FIG. 12.

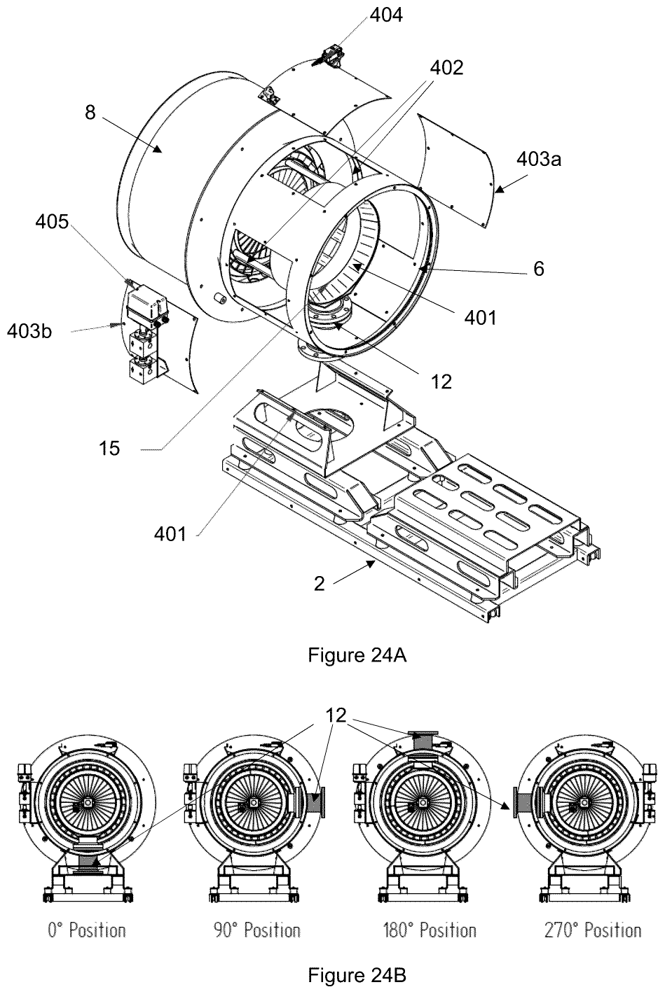

The primary airflow chamber (6) and combustion chamber (8) may be mounted on the support structure (2) in one or more different rotational configurations to allow for the position of the gas inlet manifold (12) to be changed. As shown in FIGS. 24A and 24B, specifically, the primary airflow chamber (6) and combustion chamber (8) can be mounted on the support structure in one of four rotational configurations, such that the gas inlet manifold (12) can extend up, left, down or right, depending on the relative position of the source of gas compared to the location of the burner apparatus.

The circular wall of the primary airflow chamber (6) is mountable on the underlying support structure (2) via mount (401). The mount (401) can engage with the circular wall in four different rotational configurations to allow the gas ring burner (15) and gas ring manifold (12) to be positioned in different configurations. FIG. 24B shows the four different rotational configurations of the mounted gas ring (15)/combustion chamber (8), with the gas ring manifold (12) being positioned at 0°, 90°, 180° or 270° with respect to the bottom of the apparatus. This enables the source of gaseous fuel to be connected to the bottom, left, top or right of the apparatus, depending on the most suitable position based on the location of the apparatus and its surroundings.

A circular wall defines the primary airflow chamber (6) and comprises four rectangular windows (402) around its circumference. Panels (403a, 403b) may be provided to close the windows. The panels may be provided with different components of the apparatus and the panels are interchangeable within the windows to allow greater flexibility for the positions of the components mounted on the panels. For example, the panels may be provided with an aperture for the gas ring manifold (12), fuel valve switches (405), fire switches (404) and other components for control of the apparatus. Once the primary airflow and combustion chambers have been mounted in the desired position to give the desired angle of the gas ring, the panels can be fixed to the circular wall defining the primary airflow chamber, based on the preferred location of the various control elements, and these can be wired/connected to the respective parts of the burner apparatus.

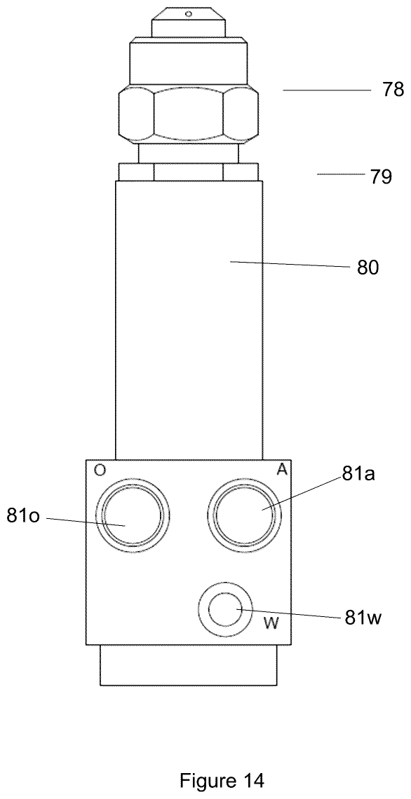

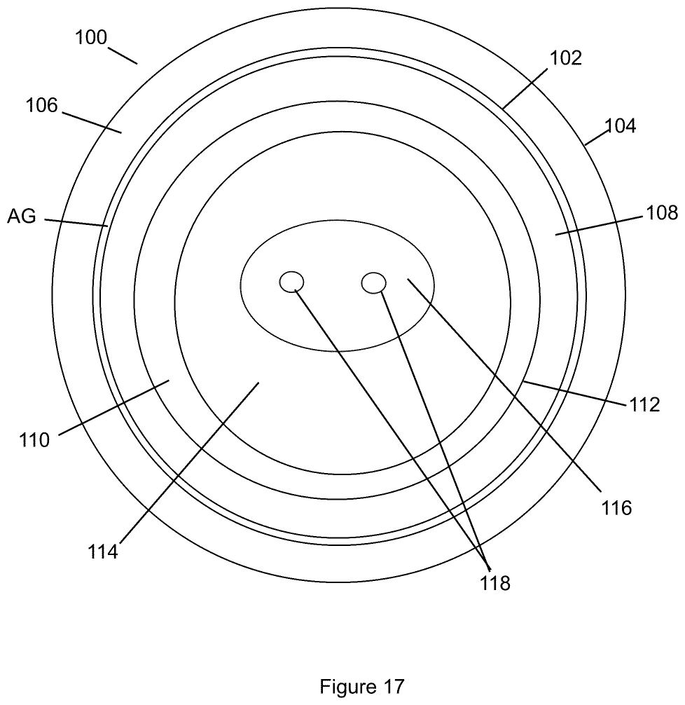

Also mounted inside the primary airflow chamber (6) is a burner lance (16) which is connected to a pressurised source of liquid fuel such as a liquid hydrocarbon or mixture of hydrocarbons. An atomising nozzle (16a) of the burner lance (16) sits in the centre of the upstream end of the combustion chamber. Electric ignition devices (not shown) for the burner lance (16) and the burner ring (15) are connected via electrical cables to a suitable power source. In the embodiment shown, only one burner lance is present. However, it is possible to use more than one burner lance, as shown in the embodiment of FIG. 17 and described below. The burner lance (16), as well as being connected to a pressurised fuel source, is also connected to an air source so that fuel and air can be mixed before being ejected in atomised form through an outlet of the burner lance. In addition, the burner lance (16) can be connected to a supply of water and configured to eject a fine cooling spray or mist of water into the burner flame in order to cool the flame. A burner lance configured to dispense a fine spray or mist of water, and the associated water supply components, are shown in FIGS. 14 to 16, and described in more detail below.

Air flow from the primary airflow chamber (6) into the combustion chamber (8) is controlled by an airflow modifier arrangement comprising a generally circular inner swirl plate (10) and an outer air-deflector element (13).

The inner swirl plate (10) is fitted with air twist blades (18). The air twist blades (18) are inclined at an angle of about 45° with respect to the central axis of the burner and impart a twist to the airstream. By configuring the airflow modifier device such that it twists the airstream as it passes through the swirl plate, the turbulence of the airstream is increased and therefore the efficiency of mixing of the combustion air with atomised fuel from the atomising nozzle is greatly improved.

The outer air-deflector element (13) is also provided with air twist blades which impart a twist to air passing therethrough and improve the efficiency of mixing of the air with gas emerging from the holes in the gas ring (15). In FIGS. 4, 6 and 11, the inner swirl plate (10) and outer air-deflector ring (13) are separate elements radially spaced apart by the gas ring (15). Thus, the inner swirl plate in mounted concentrically within the gas ring (15) whereas the outer air-deflector ring (13) is mounted concentrically to the outside of the gas ring.

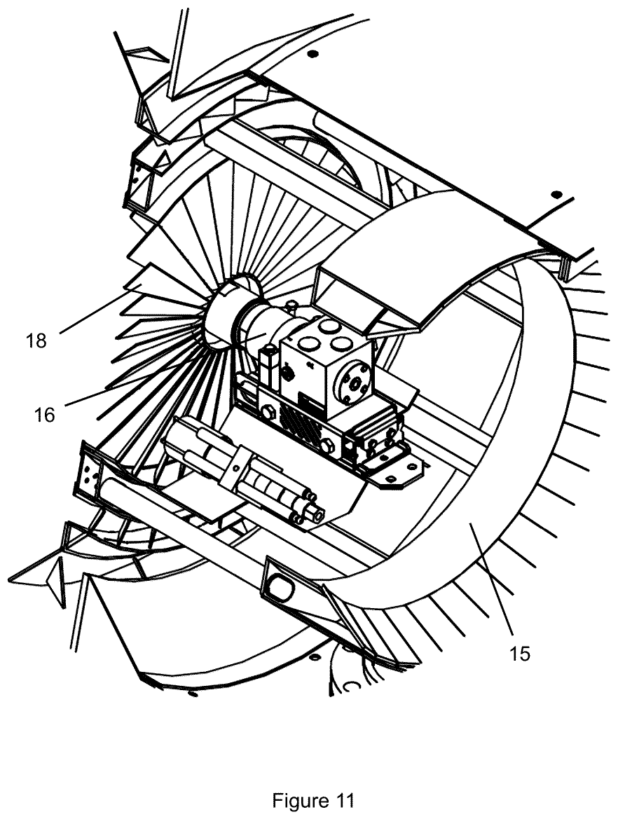

However, in an alternative embodiment, they can be linked to gather to form part of a unitary airflow modifier element as shown in FIGS. 1, 5 and 10.

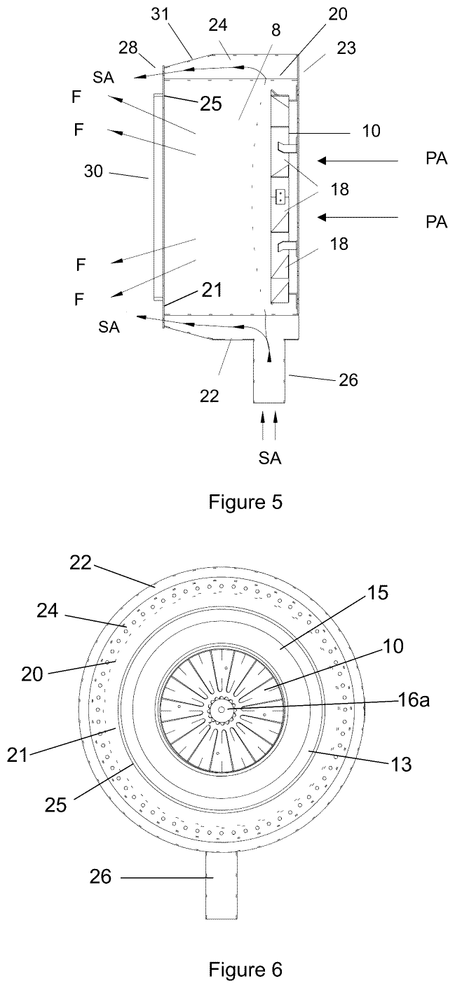

FIG. 5 is a sectional view of the combustion chamber (8) of the burner apparatus shown in FIG. 1. The combustion chamber housing has an inner skin (20) and an outer skin (22) linked by annular end walls (21) and (23), the void between the inner and outer skins forming an annular secondary airflow chamber (24). The downstream end of the combustion chamber (8) has an opening (30), bounded by a cylindrical rim (25), through which combustion products can leave the combustion chamber in the form of a flame.

A secondary airflow inlet (26), which is connected to a pressurised (e.g. pumped) source of secondary air, is present on the underside of the outer skin (22). The downstream end of the annular chamber (24) has an annular opening (28) through which air can escape the chamber. At its downstream end, the outer skin has an angled portion (31) which serves to direct airflow radially inwardly as it passes through the annular opening (28).

In use, when the burner is set up to burn a liquid fuel such as a liquid hydrocarbon, a stream of primary air (PA) from the blower module passes through the swirl plate where it is twisted by the air twist blades (18) and undergoes turbulent mixing with the atomised fuel from the atomising nozzle (16) of the burner lance (16). The fuel air mixture is initially ignited by the electric ignition device, whereafter the flame is self-sustaining, and the resulting flame extends along the length of the combustion chamber (8) and out through the downstream opening (30).

When the burner is set up to burn a gaseous fuel such as natural gas or hydrogen, gas emerging from the holes (15a) in the gas burner ring (15) is mixed with air passing through both the inner swirl plate (10) and outer air-deflector ring (13) and ignited to give a flame (F).

As the flame (F) from either the atomising nozzle or the gas ring emerges from the opening (30), the secondary airflow leaving the secondary airflow chamber (24) comes into contact with the flame (F) and undergoes turbulent mixing with the combustion products in the flame (F) resulting in the cooling of the flame temperature. By appropriate control of the flow of secondary air, the temperature of the flame can be maintained below 1204° C. and hence the likelihood of nitrogen oxides being formed can be substantially reduced.

One or more sensors (not shown) for sensing temperature are typically located so as to provide information about the flame temperature. The flow rate of the secondary airflow can then be varied as required to maintain a desired flame temperature. The control of the secondary airflow can be carried out manually or, more preferably, it can be automated. Thus, information from the temperature sensors can be fed to a computerised controller which is programmed to vary the secondary airflow to control the flame temperature.

Instead of, but more usually in addition to, the temperature sensors, one or more nitrogen oxide detectors may be located in an appropriate location so as to monitor the formation of nitrogen oxides during a burning process. Nitrogen oxide (NOₓ) detectors are well known and are commercially available. The NOx detectors can also be connected to the computerised controller and information received from the detectors used to control the secondary airflow.

In the embodiment shown in FIGS. 1 to 6, there are separate air intakes for the primary and secondary air flows and this provides greater control over the airflows and the resulting flame temperature flame temperature.

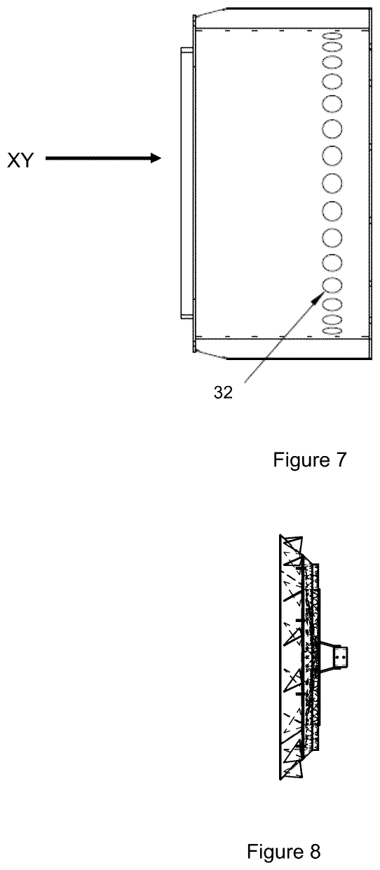

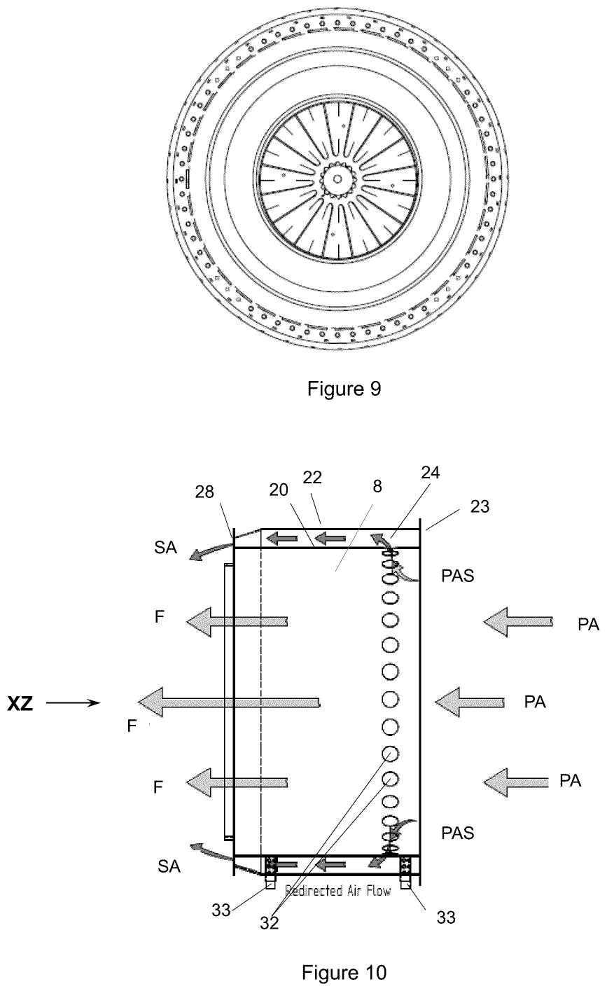

A combustion chamber according to a second general embodiment of the invention is shown in FIGS. 7 to 10.

The combustion chamber of FIGS. 7 to 10 has the same double skin arrangement as the combustion chamber of FIGS. 1 to 6 and similarly has an annular secondary airflow chamber (24) between the inner and outer skins. However, in this embodiment, there is no secondary airflow inlet set into the outer skin (22). Instead, the inner skin (20) is provided with a circumferential array of apertures (32) connecting the interior of the combustion chamber (8) with the annular secondary airflow chamber (24).

A proportion (PAS) of the primary airflow (PA) passes through an annular gap between the swirl plate (10) and the upstream end wall of the combustion chamber and is diverted outwardly and through the apertures (32) into the secondary airflow chamber (24). Air passing the secondary airflow chamber and out through the annular downstream opening (28) is incident on the flame (F) and has a cooling effect on the flame in the same manner as described above in relation to the embodiment of FIGS. 1 to 6.

The outer skin (22) is provided with two drain channels (33) which are in fluid communication with the secondary airflow chamber. This allows any unspent fuel which may accumulate between the two skins (20, 22) to be drain. The drain channels (33) are provided with drain plugs that can be used to seal the channels.

By employing a plurality of apertures (as in FIGS. 7 to 10) as opposed to a separate air intake (as in the embodiment of FIGS. 1 to 6), construction of the combustion chamber can be greatly simplified.

The flow of air through the annular gap between the swirl plate (10) and the upstream end wall of the combustion chamber and then through the apertures (32) into the secondary airflow chamber (24) can be varied by varying the size of the annular gap. An apparatus according to a fourth embodiment of the invention is shown in FIG. 13. In this embodiment, the wall of the combustion chamber has outer (60) and inner (62) skins between which is an annular secondary airflow chamber (64). The secondary airflow chamber (64) is open at its downstream end to enable a flow of cooling secondary air to be directed onto the flame as it emerges from the combustion chamber. The air inlets for the secondary airflow channel are not shown in FIG. 13.

Mounted across the upstream opening into the combustion chamber are an inner swirl plate (66), a gas ring (74), and an outer air-deflector ring (72). The outer air-deflector ring (72) has an array of angled vanes to deflect or twist air passing through openings between the vanes to facilitate mixing of the air with gas emerging from the gas ring (74).

The inner swirl plate (66) has an outer zone (68) and an inner zone (70) both of which have angled vanes to twist the airflow passing through the openings in the swirl plate (66). The outer zone (68) has approximately twice the number of vanes compared to the inner zone (70). At the centre of the inner zone (70) is an opening through which protrudes an atomising liquid fuel nozzle (78). In addition to dispensing atomised fuel, the nozzle (78) may be configured also to dispense a fine water mist to cool the flame where required. The vanes create turbulence in the airflow through the swirl plate which facilitates mixing of the air with atomised fuel and any water mist ejected from the atomising fuel nozzle (78).

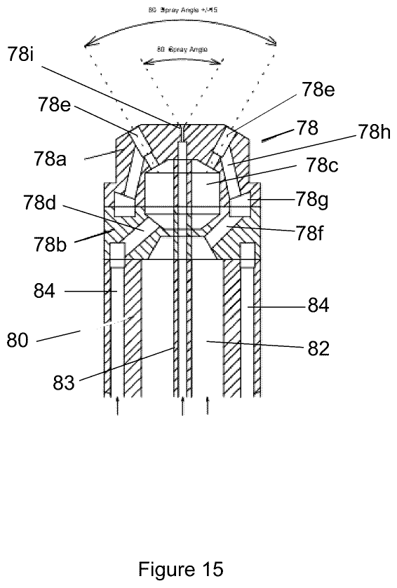

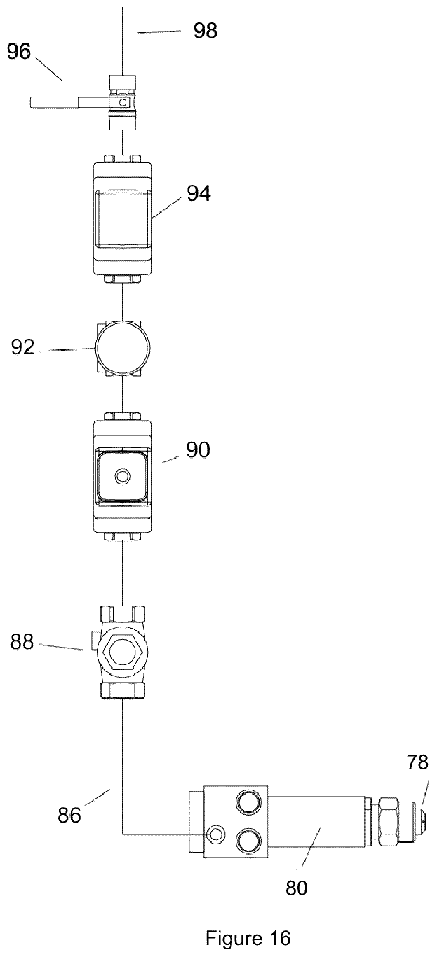

A fuel lance set up to dispense a water mist as well as atomised fuel is shown in FIGS. 14 and 15 and a water control system for controlling the flow of water to the lance is shown in FIG. 16.

The fuel lance (79) has an atomising nozzle (78) formed from a pair of nozzle body portions (78a, 78b) connected to a lance stem (80). The lance stem (80) and the two nozzle body portions (78a, 78b) are secured together by means of threads (not shown). The upstream end of the lance stem (80) is connected to an air inlet (81a), a fuel oil inlet (810) and a water inlet (81w).

A schematic view of the interior of the atomising nozzle (78) and an adjacent section of the lance stem (80) is shown in FIG. 15. Thus, the lance stem (80) has a central chamber (82) through which extends a water feeder tube (83). The tube (83) is connected at its upstream end to the water inlet (81w) and, at its downstream end, extends through the nozzle body portion (78a) and into the nozzle body portion (78b) where it communicates with a narrow mist spray aperture (78i) on the centre line of the atomising nozzle. The space (82) surrounding the tube (83) forms a fuel conduit for conveying fuel oil to the atomising nozzle and is connected at its upstream end to the fuel inlet (810). Located radially outwardly of the central chamber (82) is an annular air conduit (84) (or array of individual air passages) which is connected at its upstream end to the air inlet (81a).

The interiors of the nozzle body portions (78a) and (78b) together form a central air chamber (78c) which is connected to the air conduit (84) by a passage (78d). A plurality of passages (78e) lead from the air chamber (78c) and open out to the exterior of the nozzle (78).

At its upper end, the fuel conduit (82) is linked by one or more passages (78f) to an annular space (78g) which serves as a manifold for fuel supply passages (78h). The fuel supply passages (78h) connect with and empty into the passages (78e).

When the burner is turned on, fuel and air are pumped through the lance stem and into the atomising nozzle where they undergo turbulent mixing in the passages (78e) before being ejected from the openings at the ends of the passages (78e) as an atomised mixture of fuel in air, which is then ignited by an ignition device to create a flame. If the temperature of the flame exceeds a threshold value, water can be pumped through the water tube (83) and out through the narrow spray aperture (78i) in the form of a very fine spray or mist in order to cool the flame to below the threshold temperature. By way of example, the spray aperture (78i) can have a size of <0.1 mm or >0.4 mm which provides a flow rate of <2 litres or >2 litres per minute) at an inlet pressure of 40 PSI. In the embodiment shown, the spray aperture is configured to provide a spray angle of 80°, although nozzles having different spray angles may be used instead.

The water inlet (81w) is connected to a pumped water supply via a connector tube and a length of stainless steel hose (86) to a series of control valves consisting of a check valve (88), a solenoid control valve (90), a pressure regulator with gauge (92), a further solenoid control valve (94) and a ball valve 96), the ball valve controlling flow through the water inlet (98). In use, the volume of water pumped through the spray nozzle will be controlled in accordance with the extent of cooling of the flame required. The control valves may be operated manually but more typically will be connected to a computerised controller which in turn communicates with sensors sensing the temperature of the flame and/or concentrations of nitrogen oxides in the combustion products.

The apparatuses shown in the drawings each have a single atomising liquid fuel, water and air lance. However, there may often be circumstances where the poor availability of certain types of fuels means that it is advantageous if a burner is set up to operate using a range of different liquid fuel types as well as gaseous fuels. The apparatus of FIG. 17 is therefore provided with not only a gas burner ring but also two fuel lances (118) for burning liquid fuels.

Thus, in the apparatus of FIG. 17, as with the other embodiments described herein, the combustion chamber (100) has a wall formed from inner (102) and outer (104) skins with a secondary airflow chamber (106) between the inner (102) and outer (104) skins. The secondary airflow chamber (106) is fed with secondary air either through a separate secondary air inlet (as in FIGS. 1 to 6) or by diverting a proportion of the primary airflow outwardly through openings in the inner skin (102) (as in FIG. 7). For simplicity, the details of the secondary airflow feed are not shown in FIG. 17. The secondary airflow chamber (106) has an annular opening (not shown) at its downstream end through which the secondary airflow can be directed onto the flame as it emerges from the combustion chamber.

FIG. 22 shows the cross-section of a lance which is configured to burn two separate fuels as well as to dispense a water mist/vapour (as per the lance shown in FIG. 15). By contrast to the arrangement shown in FIG. 17, which uses two separate lances, FIG. 22 shows a single lance which is configured to burn two separate fuels, e.g. simultaneously and/or sequentially. As an example, the dual-fuel lance can be set up to simultaneously burn low pressure gas (LPG) and oil. Similarly to the lance shown in FIG. 15, the FIG. 22 lance comprises a lance stem (80), a water feeder tube (83) which extends to a narrow spray aperture (78i) in the nozzle (78) and an air conduit which extends from air inlet (81a) to the nozzle. In the lance shown in FIG. 22, there are two separate tubes (82a, 82b) which act as fuel conduits for conveying two different fuels to the atomising nozzle (78e). It will be appreciated that the lance shown in FIG. 22 is an example of a lance capable for burning two different fuels and also being provided with a water mist spray aperture, as discussed herein and that the features described with respect to the lance shown in FIG. 15 may also be present in the FIG. 22 lance.

An outer air-deflector element (108) is located concentrically within the inner skin (102), with a small radial gap (AG) between them. A cylindrical ring (not shown) of the type depicted in FIG. 17 can be provided upstream of the radial gap to control the flow of air through the gap.

The outer air-deflector element (108) is provided with an array of radially extending angled vanes (not shown) to impart twist to the airflow passing through openings between the vanes.

Located concentrically within the outer air-deflector element (108) is a gas ring (110), the gas jet openings of which are omitted for simplicity in the drawing.

Concentrically within the gas ring (110) is a swirl plate (112) comprising a circular outer zone (114) and an oval inner zone (116). Both the outer (114) and inner (118) zones are provided with angled vanes (not shown) for twisting the airflow to facilitate turbulent mixing of the primary airflow with fuel from the fuel lances (118).

The inner zone (118) of the swirl plate (112) is provided with a pair of openings through which the atomising nozzles of the two fuel lances (118).

The arrangement shown in FIG. 17 is advantageous in that it enables a greater variety of fuels to be used in the burner with minimal alterations to the set-up of the burner. In some circumstances, depending on the fuels available, only one of the fuel lances may be used in a given burning operation. In other circumstances, both fuel lances may be used simultaneously to burn different liquid fuels.

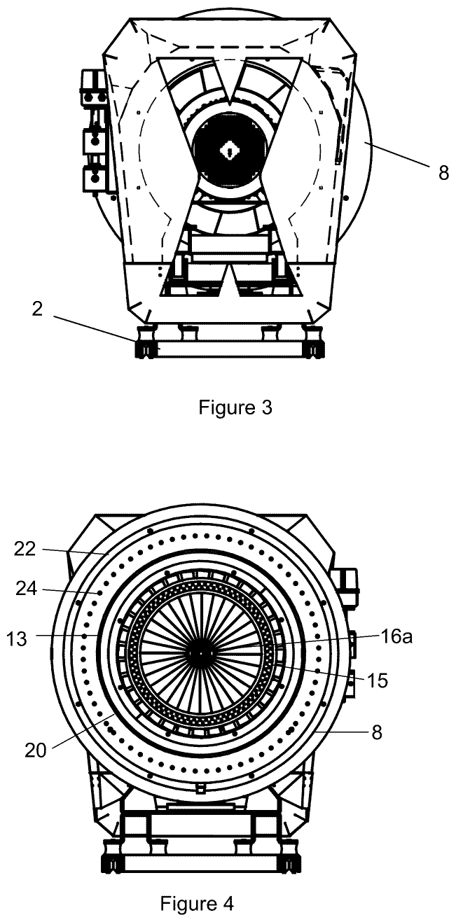

The burner apparatuses described above and shown in the drawings in use can be mounted in an opening at one end of a rotary dryer (not shown) by attachment of the flange plate (7) (see FIGS. 3 and 4) to an end wall of the rotary dryer. The rotary dryer can be of the type used for the drying of aggregates to be used in the production of asphalt.

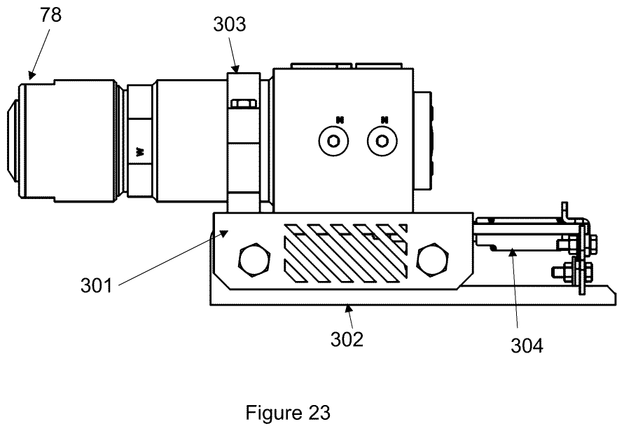

FIG. 23 shows an arrangement for adjusting the position of the burner lance with respect to the combustion chamber (8). FIG. 23 shows a burner lance (78) mounted on a moving carriage (301). The moving carriage (301) is configured to roll along a track (302) in a single direction (left-to-right in the context of FIG. 23). The track (302) is fixed to an underlying mounting plate, which does not move with respect to the combustion chamber (8). One or more actuators (304) are provided for moving the carriage (301) along the track (302) and thus moving the burner lance (78) with respect to the combustion chamber. A fixed guide plate may also be provided in order to help align the carriage (301) on the track (302). The actuators (304) may be provided with one or more sensors which act to provide a feedback mechanism for ensuring the correct position of the carriage (301) on the track (302). A clamp (303) is provided around the circumference of the burner lance (78) to fix the lance (78) and carriage (301) at a location on the track (302) once the actuator(s) has/have moved it to the correct position.

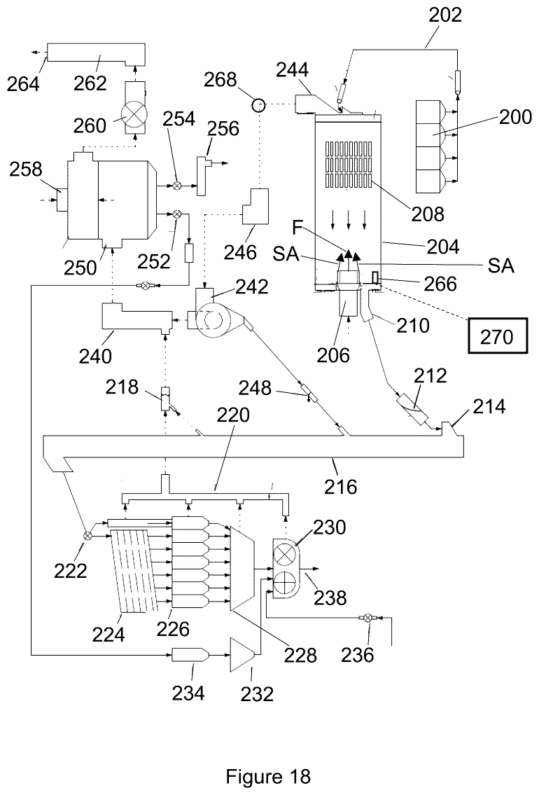

FIG. 18 is a schematic illustration of an asphalt plant incorporating a dryer equipped with a burner as described above.

The aggregates used for the manufacture of the asphalt are stored in cold storage bins (200), from which controlled amounts of aggregates are conveyed to a rotating drum dryer (204) by means of a conveyor belt (202) and are discharged through an inlet into the downstream end of the drying chamber of the rotating drum dryer (204). The aggregates can be, for example crushed stone, gravel, small stones or sand, or reclaimed asphalt materials. The aggregates in the cold storage bins will typically contain substantial amounts of moisture and will require drying before they can be mixed with bitumen to form asphalt.

The rotating drum dryer (204) is provided with a motor (not shown) or other means for rotating the drum. At the end (upstream end) of the drying chamber remote from the inlet for the aggregates, is a burner (206) of the type described above. The output from the burner, a flame creating a stream of hot gas, passes along the drying chamber from the upstream end to the downstream end. Towards the downstream end is an array of scoops or lifters (208) attached to the wall of the drum. As the drum rotates, the lifters (208) scoop up the aggregates from the floor of the drum and then release them at the top of the drum so that they fall back through the stream of heated gas passing along the drying chamber. The lifters can be of conventional shape and configuration. The axis of the drum is set at a slight incline (for example about 3.5 degrees) so that the aggregates gradually make their way along the drying chamber towards the burner (206). By the time they reach the burner end, the aggregates are dry and have been heated to a desired temperature. At the upstream end of the drying chamber, the dried heated aggregates exit via chute (210), the lower end of which is closed by a one-way door (212) which prevents air and entrained dust particles from passing back up the chute and into the drying chamber.

Upon reaching the lower end of the chute, the aggregates pass through the door (212) and into the inlet (214) of a bucket lift (216). The bucket lift is enclosed to prevent or reduce the escape of fine particulate materials to the atmosphere. The interior of the bucket lift is connected by means of a duct to a gas-flow controlling device (218). The gas flow device (218) comprises a pair of adjustable position doors, the positions of which can be varied to control the negative pressure within the duct (220) and the associated ductwork leading to the device (218). The gas-flow controlling device (218) is linked to a pressure transducer which is connected to controls (not shown) for controlling the positions of the doors.

The bucket conveyor (216) lifts the dried heated aggregates and discharges them into a chute (222) which is fitted with a diverter door to enable the aggregates to be channelled either to a vibrating screen assembly (224) or directly to hot storage bins (226). Aggregates passing into the vibrating screen assembly (224) are separated by size before being directed to the hot storage bins (226).

Arranged below the hot storage bins (226) is a weighing hopper (228) and, below the weighing hopper (228) is a mixer (230). Also arranged to discharge into the mixer (230) are a supply of molten bitumen and a chute or pipe from a hopper (232) which is connected to a silo (234) for recycled dust. The flow of molten bitumen to the mixer is controlled by a valve (236).

The bucket lift (216), vibrating screen assembly (224), hot storage bins (226), weighing hopper (228) and mixer (230) are each provided with extraction vents connected via ducts (220) and the gas-flow controlling device (218) to the primary exhaust duct (240) downstream of a coarse dust removal apparatus (242). In this way, any fine gas-entrained particulate material is collected and recycled rather than being allowed to escape into the atmosphere.

The asphalt is prepared by weighing a required amount of aggregate of a desired size range from the hot storage bins (226) into the hopper (228) and then thence into the mixer (230). Where required, an amount of recycled dust material from silo (234) may be weighed into hopper (232) and then discharged into the mixer. Molten bitumen is then added to the aggregates in the mixer and the resulting mixture is stirred to ensure that the aggregates and bitumen are well mixed, and the aggregate particles are coated with the bitumen. The hot asphalt mixture is then discharged through gate (238) into a suitable receptacle for transporting to the site of use.

During the drying of the aggregates in the drying chamber of the rotary drum dryer (204), the hot gases pass along the drying chamber to an exhaust gas outlet which leads into the end box (244) of the dryer and then into the primary exhaust duct (246). A temperature probe (not shown) is located immediately adjacent the exhaust gas outlet and measures the temperature of the exhaust gases. The primary exhaust duct (246) is connected to the coarse dust removal apparatus (242) which removes larger particles entrained in the hot exhaust gases and discharges them down a chute (248). A one-way door in the chute (248) prevents air from entering and travelling up the chute. The chute (248) discharges the coarse dust particles into the bucket lift (216) from where they are conveyed to the hot storage bins (226), either directly or via the vibrating screen assembly (224).

After the initial coarse filtration in the dust removal apparatus (224), the exhaust gases enter a filtering device (250) which removes fine dust particles from the gases. The filtering device typically comprises a bag filter, for example a filtering bag being formed from a high temperature resistant fabric such as Nomex®. A second temperature probe (not shown) is positioned in the duct immediately upstream of the filtering device. If the temperature probe senses that the temperature of the heated gas about to enter the filtering device has reached 200° C., the maximum desirable working temperature of the bag filter, the burner in the dryer is turned off.

Fine dust particles collected by the bag filter can either be discharged via a valve (252) and conveyed to the storage silo (234) or they can be discharged via valve (254) into a fine particulate conditioner (256) which mixes the dust with water to form a paste or sludge which can then be sent for disposal.

In order to prevent clogging of the bag filter, a pulsed or reverse flow through the bag filter may be introduced via inlet fan (258) to blow dust out of the filter.

Once the exhaust gases have been subjected to fine filtration, they pass through an extractor fan (260) and then into a chimney stack and out through exhaust vent (264) at the top of the chimney stack (262) into the atmosphere.

As will be understood from the description above, the asphalt plant is provided with multiple filters and recycling loops for trapping and recycling particulate matter thereby to prevent it from being released into the atmosphere. In addition, however, the apparatus of the invention is configured so as to reduce or prevent the formation of harmful nitrogen oxides. This it does by controlling the temperature of the flame produced by the burner (206). The temperature of the flame is monitored by one or more temperature sensors (266) which can be, for example, infra-red temperature sensors. In addition, levels of nitrogen oxides present in the exhaust gases from the dryer are monitored by one or more nitrogen oxide detectors (268) which can be mounted inline with the exhaust gas flow, as shown in FIG. 18 or can be mounted in the end box (244) of the dryer, or at another suitable location. Data from the temperature sensor(s) and the nitrogen oxide detectors is fed back to the computerised controller (270) either wirelessly or by cable. If the temperature and/or nitrogen oxide readings exceed predetermined limits, the operation of the burner (206), which is linked either wirelessly or by cable to the controller (270), is changed to increase the volume of secondary air (SA) flowing through the secondary air channels and impacting upon the flame (F) so as to cool the flame. In his way, by continuously monitoring flame temperatures and nitrogen oxide levels, and adjusting the secondary airflow accordingly, the amounts of nitrogen oxides formed and released into the atmosphere can be minimised.

Thus, a major advantage of the apparatus of the invention is that, by controlling the temperature of the burner flame to below the threshold temperature for the formation of nitrogen oxides, the formation of such nitrogen oxides is prevented or at least substantially reduced and hence the aerial pollution often associated with asphalt production is substantially reduced.

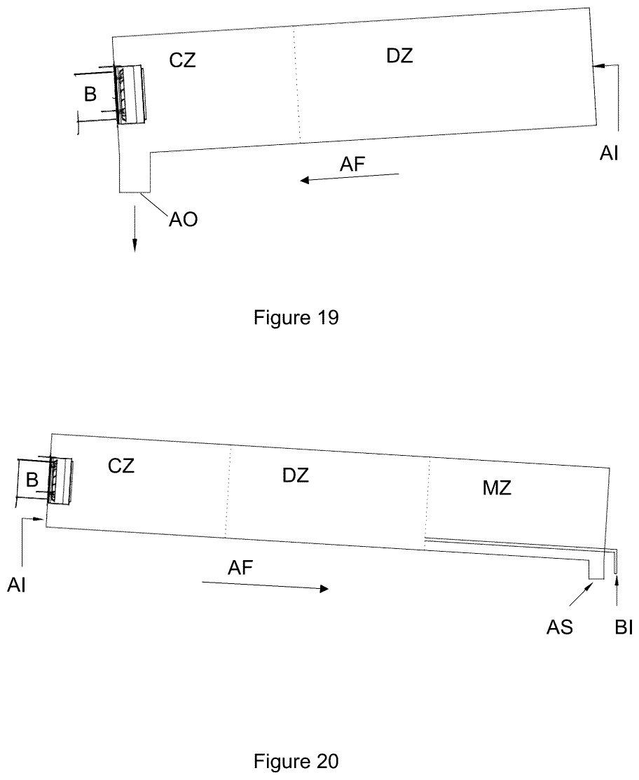

Examples of different burner-dryer configurations that the burners of the present invention can be used in are shown in FIGS. 19, 20 and 21. FIG. 19 shows a contra-flow arrangement in which the burner (B) is at the opposite end of the dryer drum to the aggregate inlet (AI) and the dryer drum is inclined upwardly towards the aggregate inlet. The interior of the dryer drum can be divided into a combustion zone (CZ), which is the region into which the flame from the burner extends, and the drying zone (DZ), which is the region where lifters are present to lift the aggregates as the drum rotates so that they fall through the hot gases produced by the burner and are dried. Aggregates are introduced into the dryer drum through inlet AI and then move down the rotating drum under the influence of gravity in direction AF to the outlet (AO).

FIG. 20 shows a parallel flow arrangement where the aggregate inlet (AI) is at the same end of the rotating drum as the burner (B) and the drum is inclined downwardly from the aggregate inlet. In this arrangement, the aggregates flow in direction (AF) under the influence of gravity through the combustion zone (CZ) and the drying zone (DZ). In addition to the direction of flow of the aggregates, the arrangement shown in FIG. 20 differs from the arrangement shown in FIG. 19 in that molten bitumen is introduced into the drum through bitumen inlet (BI) and mixes with the aggregates in the mixing zone (MZ) as the aggregates move down the drum. By the time the aggregates reach the end of the drum they have been thoroughly mixed with the molten bitumen to form asphalt which is discharged through the asphalt outlet (AS).

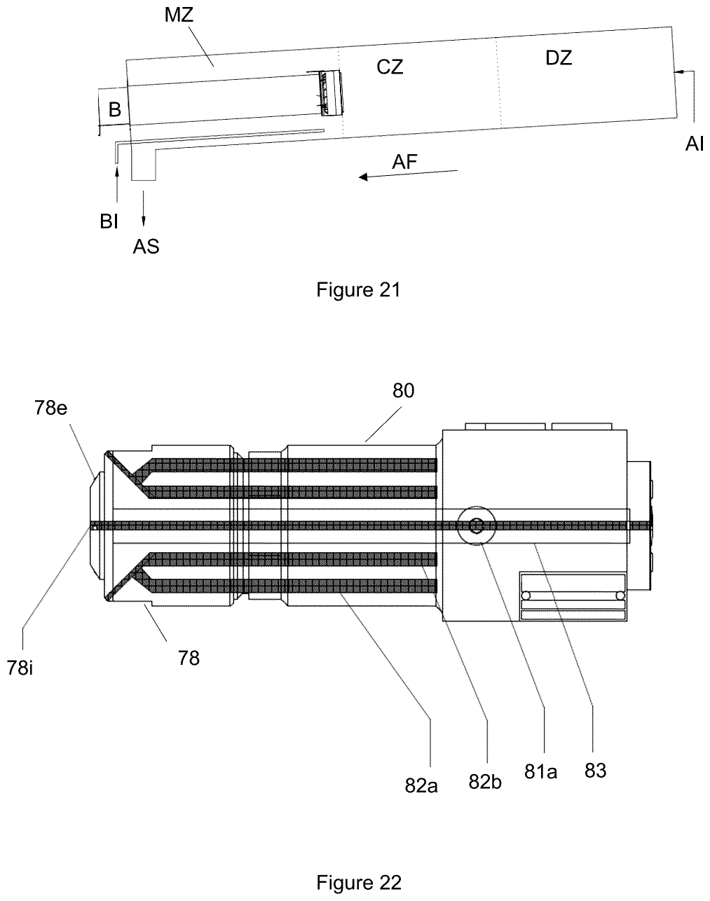

FIG. 21 also shows an arrangement in which aggregates are dried and then mixed with molten bitumen in the drum to form asphalt. In FIG. 21, however, the rotating drum has a contra-flow arrangement in aggregates enter the drum through an inlet (AI) the opposite end of the drum to the burner and then move down through the inclined drum in direction (AF) under the influence of gravity. In the arrangement shown in FIG. 21, the burner (B) is mounted such that it extends into the rotating drum by a distance of just over a third of the length of the drum. The region surrounding the burner housing constitutes a mixing zone (MZ) where aggregates having entered the drum at inlet (AI) and moved down the drum through the drying zone (DZ) and the combustion zone (CZ) come into contact with molten bitumen pumped into the drum through inlet (BI). The heated aggregates mix with the bitumen to form asphalt which is discharged through outlet (AS).

1. A burner apparatus comprising:
a combustion chamber;
a fuel dispenser arranged to direct a flow of fuel into the combustion chamber, the fuel dispenser being located at an upstream end of the combustion chamber and being connected or connectable to a fuel supply;
an airflow modifier device, located at an upstream end of the combustion chamber, for controlling a primary air flow into the combustion chamber, the airflow modifier device being configured to facilitate mixing of the air with the fuel to give a mixture for combustion; and
one or more secondary air channels for directing a cooling secondary air flow onto a stream of combustion products (e.g. flame) as the stream of combustion products emerges from a downstream end of the combustion chamber.

2. A burner apparatus according to claim 1 wherein the one or more secondary air channels are arranged to surround the combustion chamber.

3. A burner apparatus according to claim 2 wherein the secondary air channel comprises a singular annular chamber surrounding the combustion chamber.

4. A burner apparatus according to claim 1 wherein the combustion chamber and one or more secondary air channels have separate primary and secondary air intakes, respectively.

5. A burner apparatus according to claim 1 wherein the combustion chamber and one or more secondary air channels have a common air intake, and the combustion chamber is provided with one or more apertures located at the upstream end of the combustion chamber which allow a secondary air flow to pass from the combustion chamber into the one or more secondary air channels.

6. A burner apparatus according to claim 1 wherein the fuel dispenser is selected from a gas dispenser (such as a gas ring) and liquid fuel atomising nozzles, and combinations thereof.

7. A burner apparatus according to claim 6 which is provided with one or more liquid fuel atomising nozzles.

8. A burner apparatus according to claim 7 which is provided with a single liquid fuel atomising nozzle.

9. A burner apparatus according to claim 7 which is provided with a plurality of liquid fuel atomising nozzles.

10. A burner apparatus according to claim 6 which is provided with a gas dispenser (e.g. a gas ring).

11. A burner according to claim 6 wherein one or more atomising fuel nozzles are mounted (e.g. centrally) in an upstream opening into the combustion chamber, the atomising fuel nozzle(s) being connected or connectable to a source of the liquid fuel.

12. A burner apparatus according to claim 6 wherein a gas ring is mounted in an upstream opening into the combustion chamber, the gas ring being connected or connectable to a source of gaseous fuel.

13. A burner apparatus according to claim 12 wherein a said airflow modifier element is positioned radially outwardly of the gas ring.

14. A burner apparatus according to claim 12 wherein a said airflow modifier element (such as a swirl plate) is positioned radially inwardly of the gas ring.

15. A burner apparatus according to claim 1 comprising a burner nozzle arranged to dispense not only a fuel and optionally air, but also water in the form of a mist for controlling the temperature of a flame produced by the burner apparatus.

16. A dryer apparatus comprising a burner apparatus as defined in claim 1.

17. A dryer apparatus according to claim 16 that is configured for drying aggregates.

18. A method of drying aggregates, which method comprises passing the aggregates through a dryer apparatus (e.g. a rotating drum dryer apparatus) comprising a burner apparatus as defined in claim 1.
